(19) United States
(12) Patent Application Publication
(10) Pub. No.: US 2007/0102489 A1
(43) Pub. Date: May 10, 2007

(54) Ultrasonic welding head

(75) Inventors: Christian Goebl, Nuernberg (DE); Karlheinz Augustin, Fuerth (DE)

Correspondence Address: COHEN, PONTANI, LIEBERMAN & PAVANE, 551 FIFTH AVENUE, SUITE 1210, NEW YORK, NY, 10176, US

(73) Assignee: SEMIKRON Elektronik GmbH & Co. KG

(21) Appl. No.: 11/595,474

(22) Filed: Nov. 9, 2006

(30) Foreign Application Priority Data
Nov. 9, 2005 (DE) 10 2005 053 400.7

(51) Int. Cl. A47J 36/02

(52) U.S. Cl. 228/101

(57) ABSTRACT

An ultrasonic welding head for ultrasonic welding connection of a chip to a substrate is described, in which the welding parameters have a negligibly slight variation or are constant. This is attained by providing that a static friction element that increases the static friction relative to the chip to be welded is secured to the welding die of the ultrasonic welding head, and has a flat frictional end face. The static friction element is preferably formed by a ceramic chip.

### BACKGROUND OF THE INVENTION

1. Field of the Invention

The invention relates to an ultrasonic welding head for ultrasonic welding connection of a chip to a substrate.

2. Description of the Related Art

Known ultrasonic welding heads have a welding die with a welding end face. The welding end face can be embodied as being ground smooth. Another option is for the welding end face to be embodied as being indented in pyramidal form. In welding dies with a welding end face ground smooth, stress marks on the metallization of a given chip once the ultrasonic welding has been done cannot reliably be avoided. Welding dies with a pyramidally indented welding end face represent only a positive engagement with the chip edges, so that the chip edges are correspondingly mechanically stressed. Unwanted damage to a given chip because of the non-two-dimensional load is likewise often unavoidable.

With such known ultrasonic welding heads and welding dies, variations in the process parameters that must be monitored in the ultrasonic welding connection of a chip to a substrate cannot be avoided.

### SUMMARY OF THE INVENTION

Given these known conditions, it is an object of the invention, by simple means, to prevent such variations in the process parameters in ultrasonic welding of chips to substrates.

According to the invention, a static friction element is used to increase the static friction relative to the chip to be welded. The static friction element is secured to the welding die of the ultrasonic welding head and has a flat frictional end face. It has proved advantageous if the static friction element is formed by a ceramic chip. This ceramic chip may for instance be an aluminum oxide chip, a silicon carbide chip, or the like.

According to the invention, the flat frictional end face of the ceramic chip is produced by means of lapping and ensuing roughening. The roughening can be produced by etching; it can have a peak-to-valley height of from 5 to 15 μm.

The ultrasonic welding head according to the invention has the advantage that the ultrasonic energy of the ultrasonic welding head is transmitted in a process-safe way to the chip that is to be welded. This transmission of the ultrasonic energy from the flat frictional end face of the welding die of the ultrasonic welding head of the invention to the chip is accomplished by means of the static friction between the frictional end face of the welding die and the corresponding chip surface. The static friction force is the product of the normal force and the coefficient of adhesion. Since the normal force is limited by the chip construction and/or the counterpart face, the coefficient of adhesion is the sole variable that is brought about and adjusted as needed by the roughening of the flat frictional end face of the ceramic chip in order to increase the normal force.

The ultrasonic energy is introduced with the aid of the static friction element, preferably formed by a ceramic chip, in a defined way into the chip to be welded, and the welding parameters advantageously have only negligibly slight variation or in other words are quasi-constant.

Further details, characteristics, and advantages will become apparent from the ensuing description of an exemplary embodiment, shown in the drawing, of the ultrasonic welding head of the invention for ultrasonic welding of chips to substrates.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a side view of the ultrasonic welding head with a chip that is to be welded; and

FIG. 2 is an elevation view of the static friction element, formed by a ceramic chip, of the ultrasonic welding head, looking in the direction of the arrows II-II in FIG. 1.

### DETAILED DESCRIPTION OF THE PRESENTLY PREFERRED EMBODIMENTS

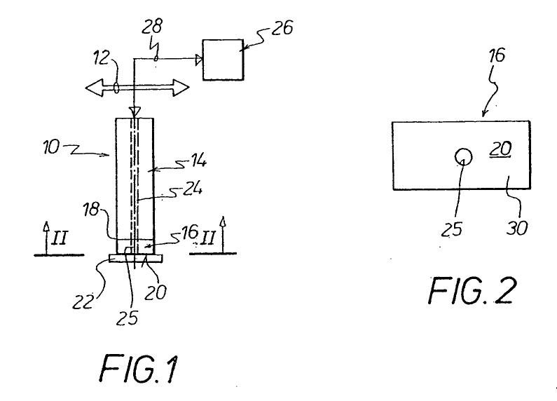

FIG. 1 shows an ultrasonic welding head 10, which in a manner known per se is set into ultrasonic vibrations. These vibrations are indicated schematically by the double arrow 12. The ultrasonic welding head 10 has a welding die 14, to which a static friction element 16 is secured. This securing is done by means of a suitable adhesive 18. Before the static friction element 16 is firmly adhesively bonded to the welding die 14, the static friction element 16 is first lapped and then roughened on its frictional end face 20 remote from the welding die 14. This roughening is preferably done by etching. The peak-to-valley height of the roughening of the frictional end face 20 of the static friction element 16 amounts for instance to from 5 to 15 μm.

For picking up a chip 12, to be firmly welded to a circuit, by suction at the ultrasonic welding head 10 or at the frictional end face 20 of the static friction element 16, a through hole 24 extends through the welding die 14 and is axially aligned with a through hole 25 that is embodied in the static friction element 16.

The ultrasonic welding head 10 can be connected or is connected to a vacuum source 26, which is shown schematically as a block in FIG. 1. The connection of the vacuum source 26 to the ultrasonic welding head 10 is represented by the angled arrow 28.

The static friction element 16 is formed by a ceramic chip 30, which by way of example has a rectangular outline at the base, as can be seen from FIG. 2. Reference numeral 25 also designates the through hole embodied in the ceramic chip 30 in FIG. 2.

The ceramic chip 30 comprises a wear-resistant ceramic, and the frictional end face 20 of the ceramic chip 30 has a defined surface roughness or in other words roughening, which is preferably produced by etching.

The ultrasonic energy of the ultrasonic welding head 10 is introduced into the chip 22 to be welded via the flat frictional end face 20 of the ceramic chip 30 of the static friction element 16. The welding parameters are advantageously quasi-constant.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An ultrasonic welding head for ultrasonic welding connection of a chip to a substrate, comprising:
a welding die; and
a static friction element secured to the welding die, the static friction element increasing the static friction of the welding die relative to the chip to be welded and comprising a flat frictional end face.

2. The ultrasonic welding head of claim 1, wherein the static friction element is formed by a ceramic chip.

3. The ultrasonic welding head of claim 2, wherein the flat frictional end face of the ceramic chip is a roughened surface produced by lapping and roughening.

4. The ultrasonic welding head of claim 3, wherein the roughened surface of the frictional end face is produced by etching.

5. The ultrasonic welding head of claim 3, wherein the roughened surface has a peak-to-valley height of 5 to 15 μm.
